(19) United States
(12) Patent Application Publication
(10) Pub. No.: US 2016/0187921 A1
(43) Pub. Date: Jun. 30, 2016

(54) WRITING SURFACE FOR COOPERATION WITH A LAPTOP

(71) Applicant: McCullough Shriver, Marlborough, CT (US)

(72) Inventor: McCullough Shriver, Marlborough, CT (US)

(21) Appl. No.: 14/587,280

(22) Filed: Dec. 31, 2014

(51) Int. Cl. G06F 1/16; A47B 97/00; A47B 5/02; F16B 47/00; A47B 5/04

(52) U.S. Cl. CPC G06F 1/1607; F16B 47/00; A47B 5/04; A47B 5/02; A47B 97/00; A47B 2097/005

(57) ABSTRACT

A support for holding a planar body attached to the screen of the associated laptop which includes a suction cup for attachment to the screen of the associated computer and an elbow having first and second extremities, the first extremity cooperating with the suction cup and the second axial extremity cooperating with the planar body. In some embodiments the planar body is substantially rectangular and the second axial extremity of the elbow has a circular boss and the circular boss engages a bore in the planar body whereby the planar body may be pivotally moved about the boss. The planar body may be dimensioned to extend over at least a part of the associated keyboard.

### BACKGROUND OF THE INVENTION

The present invention is generally directed to laptop computers and workplace organization equipment. More particularly, the present invention is directed to assisting in facilitating workers who often work on crowded desk tops. Even more particularly, the present invention is directed to apparatus which is enables a worker to work efficiently even in a crowded desktop or workspace such as that typically found in public coffee shops.

An example of a common operating environment for many laptop users is a coffee shop. In a typical coffee shop a laptop users will often attempt to work in a small space occupied by a laptop, a snack, a beverage, a mouse, pens and pencils in addition to newspapers, work papers and books etc. Some laptops do have a very small area adjacent to the keyboard that is sufficiently large and planar to allow the user to at least sign a paper with his signature. Some other work sites may suffer from the tendency of piles of paper in a workplace to build up around the workers worksite. Other laptop operating environments such as a couch or bed pose similar space limitations.

### SUMMARY OF THE INVENTION

Accordingly, it is an object of the present invention to provide an apparatus that can be easily attached to a laptop.

It is another object of the present invention to provide apparatus that includes a planar surface that enables the user to have a suitable writing surface available even in such cramped surroundings either above the keyboard or to a side of the keyboard.

It is yet another object of the present invention to provide apparatus it will be mounted at a higher elevation when disposed to a lateral side of the keyboard with the writing surface above any surrounding accumulation of objects such as pens and pencils.

It is a still further object of the present invention to provide apparatus that can be inexpensively and easily manufactured.

The apparatus in accordance with the present invention includes a support for holding a planar body attached to the screen of the associated laptop which includes a suction cup for attachment to the screen of the associated computer and an elbow having first and second extremities, the first extremity cooperating with the suction cup and the second axial extremity cooperating with the planar body.

In some embodiments the planar body is substantially rectangular and the second axial extremity of the elbow has a circular boss and the circular boss engages a bore in the planar body whereby the planar body may be pivotally moved about the boss. The planar body may be dimensioned to extend over at least a part of the associated keyboard.

The apparatus may further including a first yoke joining said suction cup and said first axial extremity of said elbow. The first yoke may be fixed to the elbow. The apparatus may further include a second yoke joining the planar body to the second axial extremity of the elbow. The second yoke joining said planar body to said second axial extremity of said elbow may be fixed to the elbow.

Other embodiments have other pivoting connections between said the second axial extremity and the generally planar surface.

Additional features and advantages are realized through the techniques of the present invention. Other embodiments and aspects of the invention are described in detail herein and are considered a part of the claimed invention.

The recitation herein of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

The subject matter which is regarded as the invention is particularly pointed out and distinctly claimed in the concluding portion of the specification. The invention, however, both as to organization and method of practice, together with the further objects and advantages thereof, may best be understood by reference to the following description taken in connection with the accompanying drawings in which:

FIG. 1 is an isometric view of one form of the writing surface in accordance with the present invention mounted on a laptop.

FIG. 2 is an isometric view of the same apparatus in illustrated in FIG. 1 in which the writing surface has been pivotally moved to a position over the keyboard of the laptop.

FIG. 3 is a front view of the apparatus illustrated in FIG. 2.

FIG. 4 is a top view of the apparatus illustrated in FIG. 2.

FIG. 5 is a top view of the support which connects the writing surface to the screen of the laptop.

FIG. 6 is an isometric view of support which connects the writing surface to the screen on the laptop.

FIG. 7 is a front view of the support which connects the writing surface to the screen of the laptop.

FIG. 8 is a side view of the support connects the writing surface to the screen of the laptop.

### DETAILED DESCRIPTION

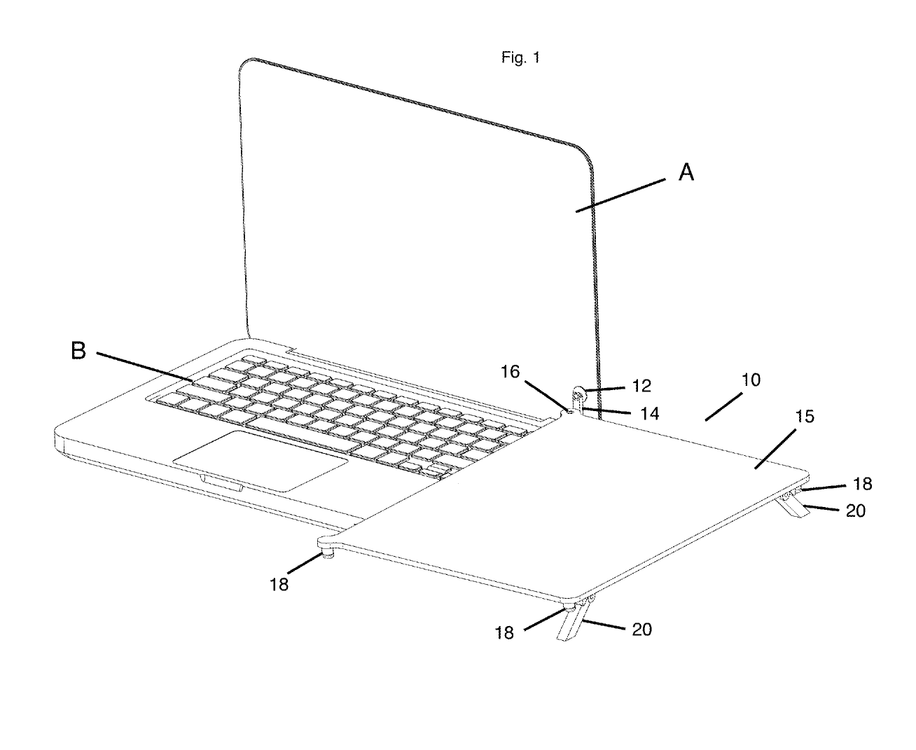

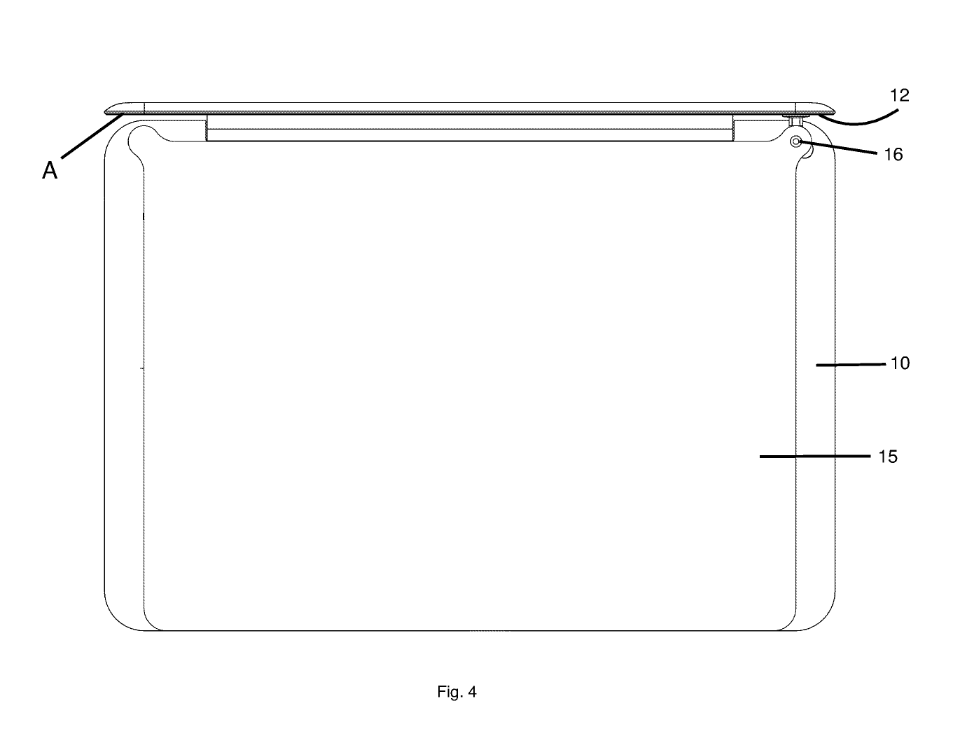

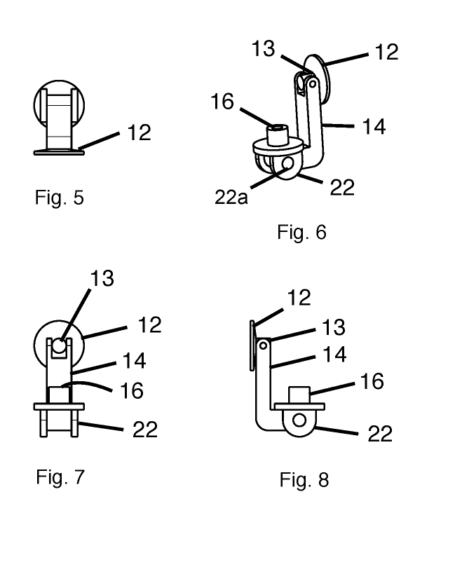

Referring to FIGS. 1-8 is shown a laptop having a screen and a keyboard be as best seen in FIG. 1 the apparatus 10 in accordance with one form of the invention attaches to the screen A planar writing surface 15 is illustrated in FIG. 1 positioned for use concurrently with the use of the keyboard B and the Display Screen A.

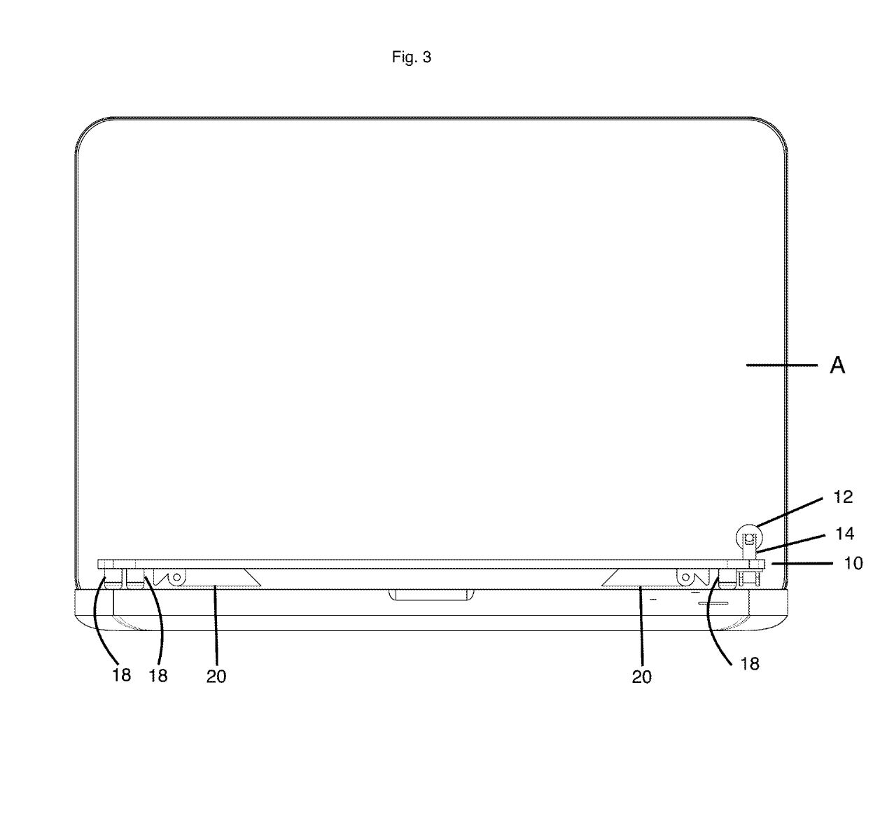

A suction cup 12 is attached to the display screen A. More specifically the suction cup 12 includes a hub on the back thereof to which an elbow 14 is attached. In the relative positions of the apparatus 10 and the laptop shown in FIG. 1 the writing surface is supported at the corner nearest the elbow 14 by a boss 16 that is dimensioned and configured for engagement with a hole in the corner of the planar surface 15. More specifically the fit between the boss 16 and the hole in the corner of the planar surface 15 allows easy rotational movement of the apparatus 10 about the boss 16. Folding legs 20, that are obliquely disposed, as well as a vertical legs 18 support the planar surface 15 in the FIG. 1 illustrated position. Each of the folding legs 20 is carried by the planar surface by a pivotal mounting as shown in FIGS. 1 and 3. Other embodiments may have screw threads on the boss 16 which may extend above the upper surface of the planar surface 15. A nut may engaged such threads on the boss 16.

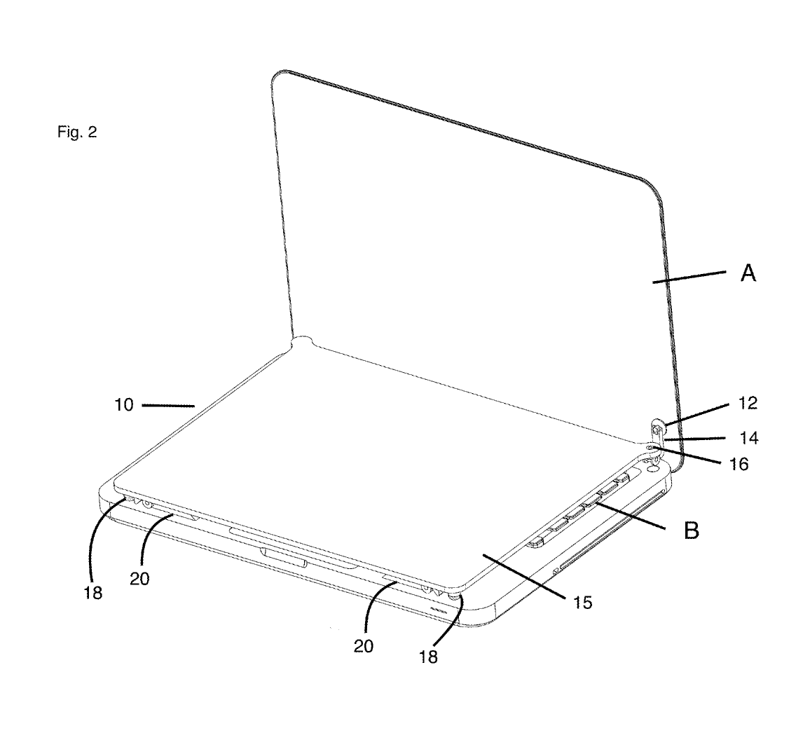

The user of the apparatus 10 may at times wish to write something when the user does not need access to the keyboard. At such times the planar surface 15 can be rotated about the boss 16 to the position shown in FIG. 2. In this position the planar surface 15 is supported by the boss 16 the folding legs 20 in addition to the vertical legs 18.

In the preferred embodiment the connection between the elbow 14 and the hub 13 of the suction cup 12 is attained with a first yoke formed at the upper axial extremity of the elbow 14. In the same embodiment the boss 16 is supported by the elbow 14 that is connected by a pin 22 to the bottom axial extremity of the elbow 14. More particularly, the reference numeral 22 identifies a yoke that connects the boss 16 to the lower extremity (as viewed) of the elbow 14. The term yoke as used herein to refers to structure sometimes called a clevis yoke. Typically such yokes have first and second opposed walls. Each wall has a bore therein, the respective bores are axially aligned whereby a pin may extend through the respective bores and engage another member whereby relative rotational movement can occur. This engagement is analogous to the connection within a conventional automobile reciprocating internal combustion engine between a connecting rod and a piston. The yokes in the present invention allow the user to adjust the rake angle, the included angle between the keyboard and the display, to suit the preference of the user.

Although the elbow in the illustrated embodiment has first and second elongated legs disposed with an included angle of 90 degrees it will be understood that other embodiments may have other included angles. More particularly, the included angle may be more than 90 degrees or even less than 90 degrees. Some embodiments may have first and second discrete legs secured together by a threaded fastener that allows the user to choose whatever angle is desired. Accordingly, the user is able to adjust the angle to allow any desired rake angle of the display A. The boss 16 may have external screw threads for engagement with a nut or even a sleeve within the planar surface 15 that rotates with respect to the planar surface 15.

While the invention has been described in detail herein in accordance with certain preferred embodiments thereof, many modifications and changes therein may be effected by those skilled in the art. Accordingly, it is intended by the appended claims to cover all such modifications and changes as fall within the spirit and scope of the invention.

1. An attachment for use with an associated laptop having a display screen and a keyboard which comprises:
a planar body dimensioned to extend over at least a part of the associate keyboard; and
a support for holding said planar body attached to the screen of the associated laptop which includes a suction cup for attachment to the screen of the associated computer and an elbow having first and second axial extremities, said first axial extremity cooperating with said suction cup and said second axial extremity cooperating with said planar body, said planar body being pivotable between a first position above the keyboard of the associated laptop and a second position adjacent to said keyboard of the associated laptop whereby the user has a writing surface either above the keyboard of the associated laptop or adjacent to the keyboard of the associated laptop.

2. The apparatus as described in claim 1 wherein said planar body is substantially rectangular.

3. The apparatus as described in claim 1 wherein said second axial extremity of said elbow has a circular boss and said circular boss engages a bore in said planar body whereby said planar body may be pivotally moved about said boss.

4. The apparatus as described in claim 1 further including a first yoke joining said suction cup and said first axial extremity of said elbow.

5. The apparatus as described in claim 4 wherein said first yoke is fixed to said elbow.

6. The apparatus as described in claim 5 further including a second yoke joining said planar body to said second axial extremity of said elbow.

7. The apparatus as described in claim 3 further including a second yoke joining said planar body to said second axial extremity of said elbow.

8. The apparatus as described in claim 7 wherein said second yoke is fixed to said boss.

9. The apparatus as described in claim 1 wherein second axial extremity has a pivotal connection to said generally planar surface.
